(19) United States
(12) Patent Application Publication
(10) Pub. No.: US 2010/0205953 A1
(43) Pub. Date: Aug. 19, 2010

(54) Case Drain Line Pressure Switch With Automatic Fan Drive Motor Shutdown

(76) Inventors: Leonard A. Bettin, LaGrange Park, IL (US); Darwin Steffensen, Racine, WI (US)

Correspondence Address: CNH AMERICA LLC, INTELLECTUAL PROPERTY LAW DEPARTMENT, 700 STATE STREET, RACINE, WI, 53404, US

(21) Appl. No.: 12/371,293

(22) Filed: Feb. 13, 2009

(51) Int. Cl. F15B 20/00; F04D 13/04; F15B 13/042

(52) U.S. Cl. 60/455; 417/375; 60/459

(57) ABSTRACT

A case drain circuit particularly well suited for use with a bulk fill subassembly or a vacuum fan assembly of an agricultural implement towed by a tractor or similar vehicle includes a pressure switch that may cause illumination of an in-cab warning light and/or sounding of an in-cab alarm when pressure in the case drain circuit exceeds a predetermined threshold. A fan is driven by a solenoid controlled hydraulic motor which is supplied hydraulic fluid under pressure from a flow control valve to the motor in accordance with electrical signals that are supplied to the solenoid by a controller. The case drain circuit provides a pathway along which leakage fluid from the motor may be delivered to a fluid reservoir, preferably carried by the towing vehicle. During undesirable high pressure conditions in the case drain circuit, the pressure switch provides a corresponding high pressure signal to the controller that in turn cuts electrical current to the solenoid to cut the flow of hydraulic fluid to the motor.

### FIELD OF THE INVENTION

The present invention relates generally to hydraulic systems for agricultural and construction implements and, more particularly, to a case drain circuit having a pressure switch that shuts down a fan drive motor, from which the case drain circuit receives leakage fluid, during undesirable pressure levels in the case drain circuit.

### FIELD OF THE INVENTION

To improve efficiency many planters are equipped with a bulk fill subassembly. Commonly, a bulk fan drive will include two large tanks or hoppers that are mounted to the planter frame. The tanks are typically loaded with seed and metering systems deliver the seed from the tanks in a controlled manner to the individual seed units carried by the seeder. The metering systems commonly include, or are operable with, a fan assembly that produces an air stream in which product from the tanks is delivered to the individual seed units. In many setups, the bulk fill fan assembly is driven by a solenoid controlled hydraulic motor. Electronic signals are sent to the solenoid, which varies the position of a corresponding valve to control the flow of hydraulic fluid or oil to the motor.

The hydraulic system generally consists of a hydraulic fluid supply line, a hydraulic fluid return line, and a case drain line that delivers leakage fluid from the hydraulic motor to a fluid reservoir, which is generally carried by the tractor rather than the seeder. For most bulk fill subassemblies, the subassembly will include corresponding hydraulic hoses for the aforementioned hydraulic lines that are fitted with suitable couplers for coupling the hoses to the hydraulic system of the tractor that is towing the seeder. In one exemplary configuration, the hose for the case drain line of the bulk fill subassembly will have a male quick connect coupler that interfaces with a female quick connect coupler of the tractor's case drain hose. The case drain line is typically a low pressure line with a pressure generally less than 25 psi. If the connection between the male and female couplers is not made properly or if the connection is broken while the hydraulic motor is turning, the pressure in the case drain line can buildup, and quickly, resulting in motor failure. The likelihood of damage to the motor is particularly acute since most bulk fill assemblies do not provide any audio or visual warning that the connection between the tractor and the bulk fill case drain lines is disconnected or has otherwise become broken.

In addition, a planter will also typically include one or more vacuum fans that are driven by hydraulic motors. Through various connections, such as a T-connection, the case drain lines for these additional hydraulic motors will be connected to the case drain line for the bulk fill fan motor, with a single case drain line being connected to the tractor.

One proposed solution is to dump fluid in the case drain line to atmosphere, but this is not environmentally preferred and can lead to a complete draining of hydraulic fluid of the tractor.

### SUMMARY OF THE INVENTION

The present invention is directed to a case drain circuit particularly well suited for use with a bulk fill subassembly or other fan driver assembly of an agricultural implement towed by a tractor or similar vehicle and that includes a pressure switch that may cause illumination of an in-cab warning light and/or sounding of an in-cab alarm when pressure in the case drain circuit exceeds a predetermined threshold. The bulk fill subassembly, as well as vacuum fan assemblies, each include a fan that is driven by a respective solenoid controlled hydraulic motor. Hydraulic fluid is supplied under pressure from solenoid controlled flow valves to the motors in accordance with electrical signals that are supplied to the solenoid by a controller. The case drain circuit provides a pathway along which leakage fluids from the motor may be delivered to a fluid reservoir, preferably carried by the tractor or other vehicle towing the agricultural implement. During undesirable high pressure conditions in the case drain circuit, the pressure switch provides a corresponding high pressure signal to the controller that in turn cuts electrical current to the solenoid that controls the flow of hydraulic fluid to the motor to effectively shut down the hydraulic motor.

The case drain circuit may also include an auxiliary fluid dump into which hydraulic fluid may be delivered during high pressure conditions in the case drain circuit. The fluid dump may include a float switch that is activated when the fluid level in the dump reaches a predetermined level. Activation of the float switch may also cause illumination of the in-cab light and/or sounding of the in-cab alarm. Moreover, the float switch may provide a corresponding signal to the controller for the solenoid that responsive thereto cuts current to the solenoid to effectively shutdown the hydraulic motor.

It will thus be appreciated that it is an object of the invention to provide a warning system that signals undesirable pressure conditions in the case drain circuit of a planter.

It will also be appreciated that it is an object of the invention to cause automatic shutdown of a fan driven motor during undesirable pressure conditions in the case drain line for the hydraulic motor.

It is another object of the invention to provide a fluid dump into which hydraulic fluid may be delivered from the case drain line during high pressure conditions in the case drain line.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE FIGURES

Preferred exemplary embodiments of the invention are illustrated in the accompanying drawings in which like reference numerals represent like parts throughout.

In the drawings:

FIG. 1 is an isometric view of a bulk fill assembly and a case drain circuit according to one embodiment of the invention;

FIG. 2 is a simplified schematic diagram of a hydraulic circuit for a hydraulic motor that rotates a fan that generates an air stream into which product may be deposited from the bulk fill assembly for delivery to a network of seed units of the planter shown in FIG. 1 according to one aspect of the invention; and

FIG. 3 is a simplified schematic diagram of an alternate hydraulic circuit according to another aspect of the invention.

### DETAILED DESCRIPTION OF THE INVENTION

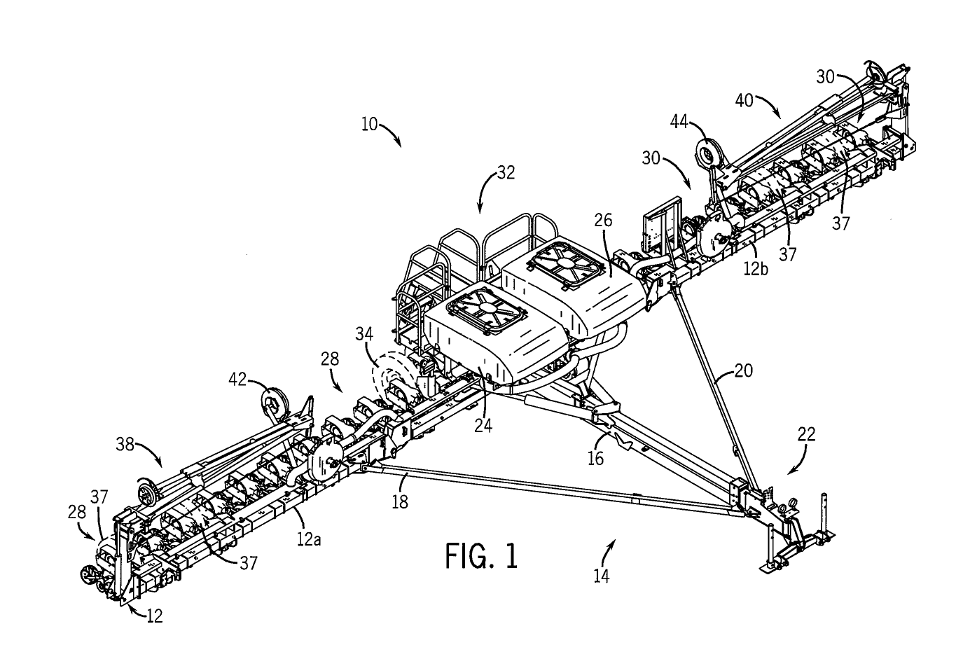

A planter 10 is shown in FIG. 1 and generally includes a frame 12 that extends generally transverse to a path of travel. The frame 12 carries a yoke 14 that includes a center beam 16 and a pair of support arms 18, 20. The center beam 16 and the support arms 18, 20 are connected to a hitch assembly 22 for coupling the planter 10 to a tractor (not shown) or similar towing vehicle.

The frame 12 also supports a pair of tanks 24, 26 that carry seed, fertilizer or other planting material to be deposited onto the planting surface. Planting material is fed from the tanks 24, 26 in a conventional manner using a metering subassembly (not shown) to two sets of row or dispensing units 28, 30, respectively. The row units 28, 30 are spaced linearly along the frame 12 and include a material dispensing port associated with a material hopper, furrow opener, and a packer wheel, as known in the art. One skilled in the art will appreciate that material is fed from the tanks 24, 26 to the individual material hoppers of each row unit. The material metering system controls the dispensing of material from the individual hoppers. A platform 32 is mounted to a rearward portion of the frame proximate the tanks 24, 26 to enable a loader to fill the tanks 24, 26 with seed when desired.

The frame 12 and its components are supported above the planting surface by four center carrying wheels 34 (only one of which is visible in the figure) and four outer carrying wheels (all of which are designated by reference numeral 37) that support the wings 12a, 12b, of the frame 12. The frame 12 includes a pair of foldable markers 38, 40 with each including a marker wheel 42, 44, respectively, as is also known in the art, that are supported by the wings 12a, 12b when retracted (as shown in FIG. 1).

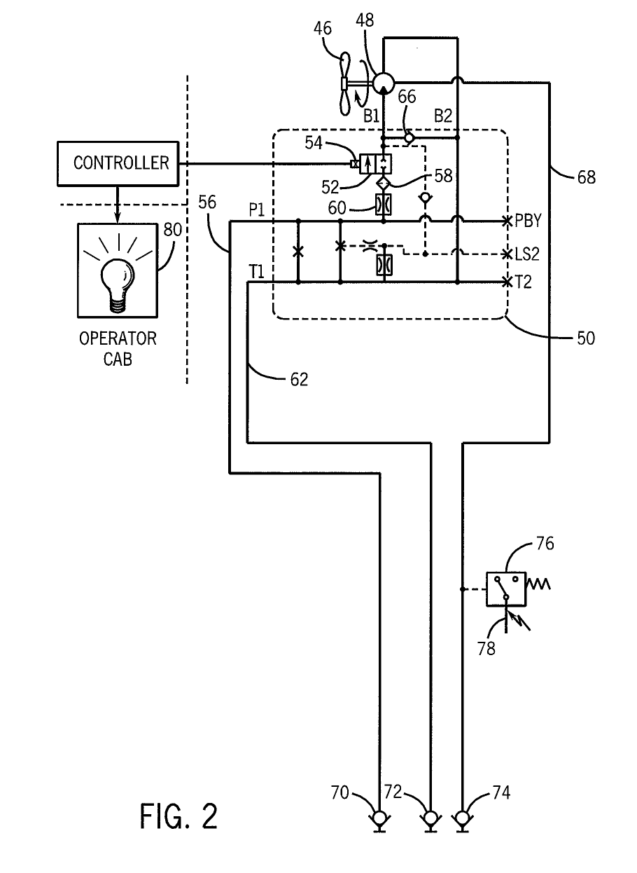

As known in the art, the metering system referenced above meters product from tanks 24, 26 and preferably into an air stream. Referring now to FIG. 2, the air stream is generated by a fan 46 that is driven by a solenoid controlled hydraulic motor 48. The hydraulic motor 48 is fed hydraulic fluid under pressure from a valve block 50 that includes a proportional flow control valve 52 whose operation is controlled by a solenoid 54. Hydraulic fluid is fed to valve 52 along a supply line 56 and is filtered by filter 58 to remove any contaminants. A flow limiter valve 60 is upstream of the filter 58 and limits the maximum flow to the proportional control valve 52. Hydraulic fluid is returned from the hydraulic motor 48 to a fluid reservoir (not shown) along fluid return line 62. Further, a check valve 66 is provided as known in the art to allow the motor 48 to coast to a stop and thereby prevent damage to the motor 48 when the proportional flow control valve 52 is closed by the solenoid 54.

A case drain line 68 is provided to pass leakage fluid from the motor 48 to the case drain circuit of the tractor. Preferably, the supply line 56 is connected to the supply circuit of the tractor using a quick connect coupler 70. Similarly, the return line 62 and the case drain are connected to corresponding circuits of the tractor using quick connect couplers 72 and 74, respectively.

In accordance with one embodiment of the present invention, a pressure switch 76 is plumbed in the case drain line 68. The pressure switch 76 is switched between a LOW pressure position and a HIGH pressure position based on the pressure in the case drain line 68. More particularly, the pressure switch 76 provides an electrical output to the controller for the solenoid 54 when pressure in the case drain line 68 exceeds a predetermined threshold. In a preferred embodiment, the threshold is below a maximum pressure that may be tolerated by the motor 48 without structural failure. When the motor 48 is running and the connection of the case drain line 68 to the case drain circuit of the tractor is broken, the pressure in the case drain line 68 will increase. When the pressure has reached the predetermined threshold, the pressure switch 76 will switch from a LOW pressure position to a HIGH pressure position and provide a corresponding signal 78 to the controller for the solenoid 54. The controller will, in turn, cut power to the solenoid 54 effectively cutting the supply of hydraulic fluid to the motor 48. The motor 48 will then coast to a stop as permitted by the coast check valve 66. Continued operation of the motor 48 will not be possible until pressure in the case drain line 68 drops below the threshold and the pressure switch resets.

In addition to shutting down the motor 48, when the pressure in the case drain line 68 exceeds the desirable working pressure, a warning light 80 in the operator cab (not shown) of the tractor is illuminated. It is contemplated that the warning light may be activated directly by the output signal of the pressure switch 76 or by a separate signal that is provided by a controller, such as the controller that controls operation of the solenoid 54. Alternately, or in addition, an alarm may be sounded when pressure in the case drain line 68 has reached the predetermined threshold. Thus, an operator sitting in the operator cab is notified that an undesirable condition is present in the case drain line 68 and that attention thereto is needed. It is further contemplated that a separate light or audible alarm may be activated by stopping of the motor 48 or the fan 46 thus signaling to the operator that operation thereof has been stopped. It is also contemplated that an air flow (sensor) may also be used to signal that the air stream is not being properly generated.

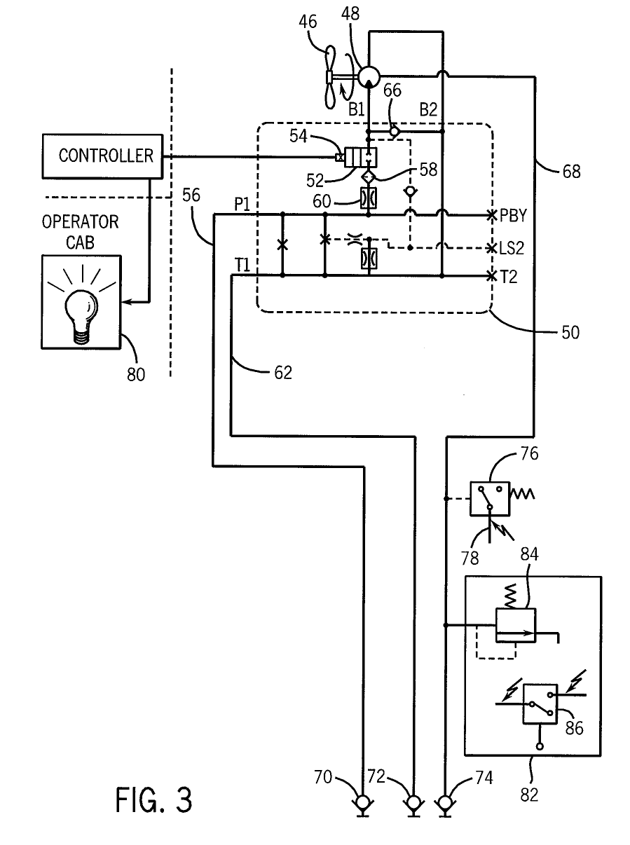

FIG. 3 shows a hydraulic circuit similar to that shown in FIG. 2 but includes a collector reservoir 82 connected to the case drain line 68 and into which hydraulic fluid in the case drain line 68 may be delivered during undesirable pressure conditions. More particularly, a pressure relief valve 84 is provided that is opened when pressure in the case drain line 68 reaches a predetermined threshold. It is contemplated that the threshold for the pressure relief valve 84 may the same or different than that necessary to switch the pressure switch 76. In preferred embodiment, the pressure relief valve 84 is opened at a greater pressure than that causes switching of the pressure switch 76. In this regard, hydraulic fluid is not fed to the collector reservoir 82 unless the response time of the pressure switch 76 is insufficient to prevent additional increases in the fluid pressure in the case drain line 68. Thus, if the pressure in the case drain line 68 continues to rise to an unacceptable or undesirable level after the pressure switch 76 has provided, in effect, a motor shutdown signal 78 to the controller for the solenoid 54, the pressure in the case drain line 68 can be lowered by opening, via valve 84, the collector reservoir 82 and allowing fluid to drain into the collector reservoir 82.

In a further embodiment, a float switch 86 is provided in the collector reservoir 82 that is activated when the fill level in the collector reservoir 82 reaches a predetermined level. In a preferred embodiment, the float switch 86 outputs a signal to the controller for the solenoid 54 similar to the output signal provided by the pressure switch 76. Thus, when the level of fluid in the collector reservoir reaches a predetermined level, the motor 48 will be shutdown.

In addition, in a preferred embodiment, when the float switch 86 is triggered, a warning light, e.g., light 80, and/or audible alarm in the operator cab of the tractor is activated signaling the operator that an undesirable condition is present in the case drain line 68 and that the float switch has been activated. It is recognized that the pressure switch 76 and the float switch 86 can cause illumination or sounding of the same lights and alarms or different lights and alarms to provide the operator with some specificity as to what is being signaled.

It will be appreciated that the float switch 86 is not reset until the hydraulic fluid is drained from the collector reservoir 82. Thus, the motor cannot be restarted when the float switch has been triggered until after the fluid level in the collector reservoir 82 has been lowered below the predetermined trigger level.

It will also be appreciated that the case drain of other hydraulic motors, such as those to drive vacuum fans, may be connected with a suitable connection to case drain line 68 and thus, if an undesirable pressure is present in the case drain line, all of the motors associated with the case drain line may be shutdown in a manner as described above.

Many changes and modifications could be made to the invention without departing from the spirit thereof. The scope of these changes will become apparent from the appended claims.

We claim:

1. An apparatus comprising:
a motor operative to drive a fan assembly;
a case drain line fluidly connected to the motor and operative to deliver leakage fluid from the motor to a fluid reservoir; and
a fluid pressure switch operative to cut power to the motor if the pressure in the case drain line reaches a first predetermined threshold.

2. The apparatus of claim 1 further comprising a solenoid and a flow control valve that controls the flow of fluid from a fluid source to the motor, and wherein the fluid pressure switch provides a close valve signal to the solenoid if the pressure reaches the predetermined threshold, wherein the close valve signal causes the flow control valve to no longer supply fluid to the motor.

3. The apparatus of claim 1 further comprising a coast relief valve that allows the motor to coast to a stop when the flow control valve is closed.

4. The apparatus of claim 2 wherein the fluid pressure switch is plumbed into the case drain line between the motor and the fluid reservoir.

5. The apparatus of claim 2 wherein the pressure switch causes automatic illumination of an in-cab warning light when the pressure in the case drain reaches the first predetermined threshold.

6. The apparatus of claim 2 further comprising a fluid collector connected to the case drain line and a pressure relief valve that causes the fluid in the case drain line to be delivered to the fluid collector if the pressure in the case drain line reaches a second predetermined threshold.

7. The apparatus of claim 6 wherein the second predetermined threshold is greater than the first predetermined threshold.

8. The apparatus of claim 6 further comprising a float switch disposed in the fluid collector that when triggered results in closing of the flow control valve.

9. The apparatus of claim 8 wherein the float switch is configured to be reset only after the fluid collector has been drained to a level below a float switch activation level.

10. The apparatus of claim 1 wherein the case drain line has a first end fluidly connected to the motor and a second end fluidly connected to the fluid reservoir, and wherein the second end includes a quick connect coupler

11. A hydraulic system for an agricultural planter having a frame adapted for movement over the ground, a tank supported on said frame for carrying a product to be dispensed to the ground, a metering mechanism for controlling the flow of the product to the ground, a fan mechanism for creating a flow of air through a conduit associated with said metering mechanism, and a remote planting mechanism for receiving the product from the conduit and depositing the product into the ground, the hydraulic system providing a source of hydraulic fluid under pressure to a hydraulic motor to power the fan mechanism, the hydraulic system comprising:
a case drain line;
a pressure switch plumbed into the case drain line and operative to cause cessation of hydraulic fluid flow to the hydraulic motor if pressure in the case drain line reaches a predetermined threshold.

12. The hydraulic system of claim 11 further comprising a solenoid and a proportional flow control valve that controls the flow of hydraulic fluid to the hydraulic motor, and wherein the pressure switch is movable between a first position at which the solenoid is energized to open the proportional flow control valve such that hydraulic fluid may be fed to the hydraulic motor and a second position at which the pressure switch provides a signal that causes the solenoid to close the proportional flow control valve so that hydraulic fluid cannot be fed to the hydraulic motor.

13. The hydraulic system of claim 12 further comprising a hydraulic fluid conduit interconnected between the motor and the proportional flow control valve, and further comprising a coast relief valve connected to the hydraulic fluid conduit and operative to allow the hydraulic motor to coast to a stop when the proportional control valve is closed.

14. The hydraulic system of claim 12 further comprising a hydraulic fluid dump fluidly connected to the case drain line, and further comprising a pressure relief valve and a float switch, the flow switch being disposed in the hydraulic fluid dump, and wherein the pressure relief valve allows hydraulic fluid to flow from the case drain line to the hydraulic fluid dump when pressure in the case drain line exceeds the predetermined threshold.

15. The hydraulic system of claim 14 wherein the float switch is operative to provide a signal that causes the solenoid to close the proportional control valve when a volume of fluid in the hydraulic fluid dump exceeds a predetermined volume.

16. An agricultural implement comprising:
a tank adapted to be filled with a product to be deposited onto a planting surface;
a metering mechanism for controlling the flow of product from the tank to the planting surface, the metering mechanism including a fan driven by a motor;
a case drain circuit fluidly connected to the motor and adapted to deliver leakage fluid from the motor to a case drain;
a hydraulic system to provide hydraulic fluid under pressure to the motor to power operation of the fan, the hydraulic system including a controller, a solenoid, and a flow control valve operative to control the flow of hydraulic fluid to the motor; and
a pressure switch plumbed into the case drain circuit and operative to output a signal to the controller based on the pressure in the case drain circuit.

17. The agricultural implement of claim 16 wherein the controller cuts power to the solenoid when pressure in the case drain circuit exceeds a first predetermined threshold.

18. The agricultural implement of claim 17 further comprising a fluid collector connected to the case drain circuit and having a pressure relief valve that allows hydraulic fluid in the case drain circuit to drain to the fluid collector when pressure in the case drain circuit exceeds a second predetermined threshold.

19. The agricultural implement of claim 18 further comprising a float switch that measures a fluid level in the fluid collector and is operative to provide a signal to the controller that causes the controller to cut power to the solenoid when the fluid level in the fluid collector exceeds a predetermined fluid level.

20. The agricultural implement of claim 18 wherein the second predetermined threshold is greater than the first predetermined threshold.

21. The agricultural implement of claim 18 wherein the second predetermined threshold is less than the first predetermined threshold.
